(19) United States
(12) Patent Application Publication
(10) Pub. No.: US 2025/0304789 A1
(43) Pub. Date: Oct. 2, 2025

(54) Polymer Composition for Contact with Cooling Fluids

(71) Applicant: Celanese Polymers Holding, Inc., Wilmington, DE (US)

(72) Inventors: Huan Zhang, Shanghai (CN); Ling Hong Wu, Shanghai (CN); Juergen Schmidt, Utzenfeld (DE)

(21) Appl. No.: 19/089,133

(22) Filed: Mar. 25, 2025

Related U.S. Application Data
(60) Provisional application No. 63/660,664, filed on Jun. 17, 2024.

(30) Foreign Application Priority Data
Apr. 1, 2024 (WO) PCT/CN2024/085174

(51) Int. Cl. C08L 77/06; C08J 5/04; C08K 5/50; C08K 7/14; C08K 9/06; C08K 9/08

(52) U.S. Cl. CPC C08L 77/06; C08J 5/043; C08K 5/50; C08K 7/14; C08K 9/06; C08K 9/08; C08J 2377/06; C08K 2201/019; C08L 2203/18; C08L 2205/24

(57) ABSTRACT

A polymer composition and molded polymer articles made from the composition are described that are particularly well suited for contact with cooling fluids in cooling fluid circulation systems. The molded polymer components, for instance, can at least partially define a cooling fluid pathway and are well suited for use in cooling batteries and other electrical components in electrical vehicles. The polymer composition contains a polyamide polymer in combination with glass fibers and at least one stabilizer.

### RELATED APPLICATIONS

The present application is based upon and claims priority to International Patent Application No. PCT/CN2024/085174, having a filing date of Apr. 1, 2024, and U.S. Provisional Patent Application Ser. No. 63/660,664, having a filing date of Jun. 17, 2024, both of which are incorporated herein by reference in their entirety.

### BACKGROUND

Electric vehicles that employ electric power for all or a portion of their motive power (e.g., electric vehicles, hybrid electric vehicles, and plug-in hybrid electric vehicles) can provide a number of advantages to more traditional gas-powered vehicles. For example, electric vehicles may produce fewer undesirable emission products and may exhibit greater fuel efficiency as compared to vehicles using internal combustion engines. As electric vehicle technology continues to evolve, there is a need to provide improved battery systems for such vehicles to increase the distance that such vehicles may travel without the need to recharge.

In this regard, manufacturers have begun to develop lithium-ion batteries that have a high charge density and can store a high level of charge. Unfortunately, lithium-ion batteries also tend to be sensitive to temperature and can thus experience failure when excessively high temperatures are reached. For example, batteries work based on the principle of a voltage differential and, at high temperatures, the electrons inside the batteries become excited which decreases the difference in voltage between the two sides of the battery. Consequently, for proper operation, the batteries need to be maintained within a particular temperature range, such as from about 18° C. to about 43° C. If large internal temperature differences occur in a battery pack or if the temperature is raised above a certain threshold, potential thermal stability issues may arise including capacity degradation, thermal runaway, or the like.

In view of the above, battery systems in electric vehicles need an effective coolant system. Various different methods and techniques have been proposed in the past in order to cool battery packs. For instance, in the past, the installation of cooling fins, air cooling, and liquid cooling systems have been proposed. Liquid coolant systems have higher heat conductivity and heat capacity. Consequently, liquid coolant systems have shown to be well suited for maintaining a battery pack within a correct temperature range.

Liquid coolant systems can include direct coolant systems and indirect coolant systems. In direct coolant systems, the battery cells are placed in direct contact with a cooling liquid. In indirect coolant systems, on the other hand, a cooling liquid is circulated through a series of pipes or tubes that indirectly cool the battery cells. In both systems, components are needed in order to circulate the cooling fluid. These components can include pumps, valves, manifolds, tubes, and the like.

In the past, many components contained in a coolant system were made from metals. Metals, however, can add weight and expense to the vehicle. Thus, a need currently exists for coolant system component parts made from lighter materials, such as polymer materials. Cooling liquids, however, can cause various different polymers to degrade. In addition, various different polymers can swell and absorb cooling liquids which can also cause the physical properties of the polymer parts to decrease.

In view of the above, a need currently exists for components and parts configured to be installed in a cooling fluid circulation system that are made from non-metals. More particularly, a need exists for a polymer composition well suited to producing components and parts for a cooling liquid system that do not degrade or otherwise deteriorate when exposed to a cooling fluid and/or have physical properties making the polymeric components or parts well suited for use in a cooling fluid system environment for an electric vehicle.

### SUMMARY

In general, the present disclosure is directed to polymer compositions and polymer articles made from the composition well suited for being used as components and parts in a cooling fluid system. The polymer articles are formed from a polymer composition containing a particular type of polyamide polymer blended with reinforcing fibers and a stabilizer. The reinforcing fibers can include a hydrolysis-resistant agent. The stabilizer can comprise a copper complex. In addition, the polymer composition can include a pigment that not only improves the appearance of molded articles made from the polymer composition but can also serve as a crystallizing agent that lowers the crystallization temperature of the polyamide polymer. In this manner, the crystallizing agent can improve the surface appearance of molded articles made from the composition.

In one aspect, the present disclosure is directed to a polymer composition well suited for contact with cooling fluids. The polymer composition contains a polyamide polymer present in the polymer composition in an amount greater than about 35% by weight, such as in an amount from about 45% by weight to about 85% by weight, such as in an amount from about 60% by weight to about 70% by weight. The polyamide polymer contains amine end groups in an amount greater than about 55 mmol/kg, such as greater than about 60 mmol/kg, such as greater than about 65 mmol/kg, such as greater than about 70 mmol/kg, such as greater than about 75 mmol/kg, such as greater than about 80 mmol/kg. The polymer composition also contains reinforcing fibers in an amount from about 5% by weight to about 55% by weight, such as in an amount from about 15% by weight to about 40% by weight, such as in an amount from about 25% by weight to about 35% by weight. The polymer composition further contains a stabilizer comprising a copper compound. In addition, the polymer composition includes at least one of a lubricant, a nucleating agent, and/or a crystallizing agent that lowers the crystallization temperature of the polyamide polymer. In one aspect, the polymer composition contains all of the components above including a lubricant, a nucleating agent, and a crystallizing agent. The crystallizing agent can also comprise a coloring agent that provides color to polymer articles made from the polymer composition.

In one aspect, the reinforcing fibers can comprise glass fibers. In one aspect, the glass fibers can be substantially free or completely free of boron. The reinforcing fibers can also include a sizing composition that has been applied to the surface of the fibers. The sizing composition can contain a hydrolysis-resistant agent. In one aspect, the sizing composition contains a silane, such as an alkoxysilane. The hydrolysis-resistant agent can comprise an anhydride- and/or carboxylic-functionalized polymer, an epoxy-functionalized polymer, or a mixture thereof. In one aspect, the hydrolysis-resistant agent comprises a blocked isocyanate.

The stabilizer present in the polymer composition can comprise a copper and organic halogen complex. In one aspect, the stabilizer comprises a complex of copper, di-u-iodotris(triphenylphosphine)di- and iodobis(triphenylphosphino) copper. The stabilizer can be present in the polymer composition in an amount greater than about 0.5% by weight, such as in an amount greater than about 0.8% by weight, and in an amount less than about 3% by weight, such as in an amount less than about 2% by weight, such as in an amount less than about 1.5% by weight.

In one aspect, the polymer composition contains the crystallizing agent. The crystallizing agent can comprise a coloring agent or pigment. In one embodiment, the crystallizing agent can comprise nigrosine. The crystallizing agent can be present in the polymer composition such that the polyamide polymer has a crystallization temperature of less than about 225° C., such as less than about 223° C., such as less than about 221° C., and greater than about 210° C.

In one aspect, the polymer composition contains the lubricant and/or the nucleating agent. The lubricant can comprise montanic acid or a montanic acid derivative.

In one aspect, the polymer composition is free of semi-aromatic or aromatic polyamide polymers.

The present disclosure is also directed to a polymer article comprising a molded polymer component defining at least a portion of a fluid flow path. The molded polymer component is configured to be a portion of a coolant circuit for circulating a cooling fluid. For example, the cooling fluid can be a glycol, such as ethylene glycol or propylene glycol. The molded polymer component is formed from a polymer composition as described above.

Various different polymer articles can be formed in accordance with the present disclosure. The polymer article, for instance, can be a distribution manifold, a valve component, a housing defining at least one cooling fluid pathway, a radiator tank, such as a radiator expansion tank, a tube, a pump component, such as an impeller, or the like.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of an electric vehicle that may incorporate parts or components made in accordance with the present disclosure;

FIG. 2 is a perspective view of one embodiment of a cooling fluid tube;

FIG. 3 is a side view of one embodiment of a manifold that may be made in accordance with the present disclosure;

FIG. 4 is a side view of one embodiment of a cooling fluid tank made in accordance with the present disclosure; and

FIG. 5 is a side view of one embodiment of a cooling fluid valve that may include components or parts made in accordance with the present disclosure.

Repeat use of reference characters in the present specification and drawings is intended to represent the same or analogous features or elements of the present invention.

### Definitions

As used herein, all cooling fluid aging tests are performed on ISO test specimen 3167 Type A. The test specimen is placed in a cooling fluid at 130° C. for 1,008 hours. The cooling fluid contains 50% by weight DEX-COOL antifreeze (monoethylene glycol/monopropylene glycol combined with 5-7% by weight additives and 3-5% by weight water) commercially available from Prestone and 50% distilled water. Prior to testing, each test specimen is pre-conditioned by being dried for 72 hours at 80° C. in a heating cabinet after molding. The test specimens can be measured for tensile stress (cooling fluid tensile stress change test), strain at break (cooling fluid strain at break change test), impact strength (cooling fluid Charpy unnotched impact strength change test) and any other tensile property.

As used herein, tensile properties are measured according to ISO Test 527-1,-2 using tensile test specimen 1A, injection molded, at a test speed of 5 mm/min.

As used herein, Charpy notched and unnotched impact strength is determined according to ISO Test 179-1/1eA using test specimen ISO 3167 Type A.

For any standardized test methods described herein, unless otherwise denoted, the latest addition of the test procedure applies.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to polymer articles that can be used to construct a cooling fluid circuit. The polymer articles are intended to be in contact with the cooling fluid. For instance, the polymer articles can comprise molded polymer components that define at least a portion of a fluid flow path (e.g. come into contact with a cooling fluid when in use). In accordance with the present disclosure, the polymer articles are formed from a polyamide polymer composition containing glass fibers, a stabilizer comprising a copper complex, and optionally a crystallizing agent that lowers the crystallization temperature of the polyamide polymer. The polymer composition can also contain a lubricant and/or a nucleating agent. The polyamide polymer selected for use in the present disclosure contains a relatively high amine end group content. It was discovered that the polymer compositions not only possess excellent physical properties but also display exceptional dimensional stability when placed in contact with cooling fluids at elevated temperatures for extended periods of time.

Polymer articles made according to the present disclosure are particularly well suited for constructing cooling fluid systems that are designed to be incorporated into electric vehicles. The cooling fluid system, for instance, can be used to cool battery packs in order to ensure that the battery cells are maintained within a preset and desired temperature range. The polymer composition of the present disclosure can be used to make any component in a cooling fluid system that comes into contact with the cooling fluid. The polymer composition also displays excellent tribological properties and can be used to produce parts that contact a cooling fluid and move between different positions such as a valve or manifold component.

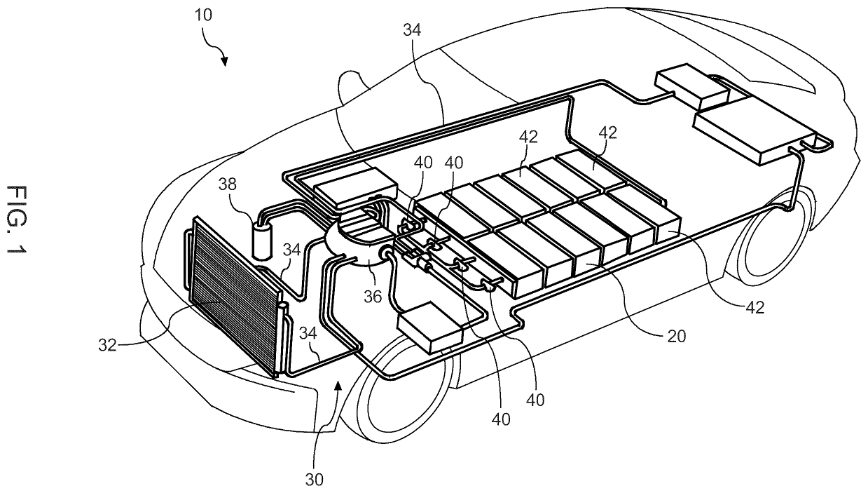

Referring to FIG. 1, one embodiment of an electric vehicle 10 is shown that illustrates a battery system 20 in communication with a cooling fluid system 30.

It should be understood that the battery system or module 20 can be employed in a wide variety of vehicles, such as an electric vehicle, a hybrid electric vehicle, a plug-in hybrid electric vehicle, or other type of vehicle using electric power for propulsion. The vehicle may be in the form of an automobile, bus, truck, motorcycle, boat, etc. In the embodiment illustrated in FIG. 1, for instance, the electric vehicle 10 is shown in the form of an automobile or car. The battery system 20 is for providing all or a portion of the motive power of the vehicle 10.

In FIG. 1, the battery system 20 is shown positioned in the center of the vehicle. The battery system 20, however, can be positioned in the trunk or rear of the vehicle or in any other suitable location. The position of the battery system 20 may be selected based on the availability of space within the vehicle, the desired weight balance of the vehicle, the location of the other components that are connected to the battery system, and a variety of other considerations.

In order to maintain the batteries contained within the battery system 20 within a preset temperature range and to prevent the batteries from overheating, the electric vehicle 10 includes the cooling fluid circulation system 30. The cooling fluid system 30 can include a radiator tank 32 that is connected to a plurality of fluid conveying tubes 34.

As shown in FIG. 1, the coolant system 30 can include a central module 36 that can contain one or more pumps, one or more valves, and one or more sliders for directing the cooling fluid around the circulation system 30. The central module 36, for instance, can be in fluid communication with an expansion or radiator tank 38 and with a plurality of temperature and/or pressure sensors 40.

As illustrated in FIG. 1, the battery system 20 can include individual battery packs that are each contained in a housing 42. Each of the housings 42 can be in communication with the cooling fluid circulation system 30 for circulating a cooling fluid through the housing 42. The cooling fluid, for instance, can directly cool each battery pack or can indirectly cool each battery pack.

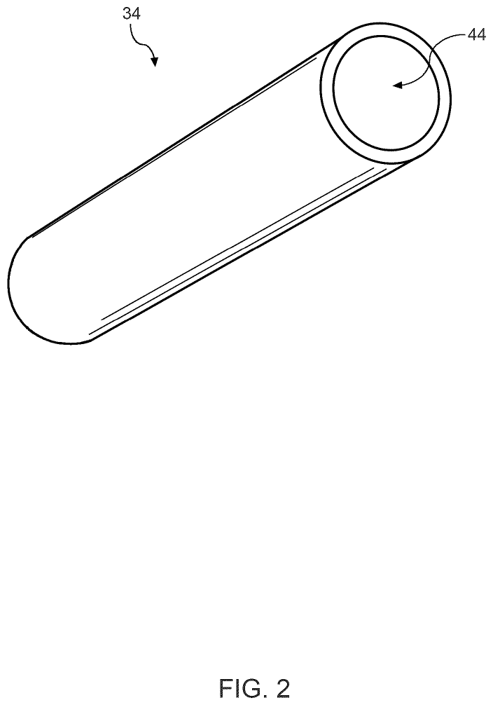

Molded polymer components made in accordance with the present disclosure are well suited for constructing any portion of the cooling fluid circulation system 30 as shown in FIG. 1. For example, referring to FIG. 2, a cooling fluid tube 34 is shown. The cooling fluid tube 34 defines a cooling fluid passage or flow path 44. The cooling fluid tube 34 can be made entirely from the polymer composition of the present disclosure.

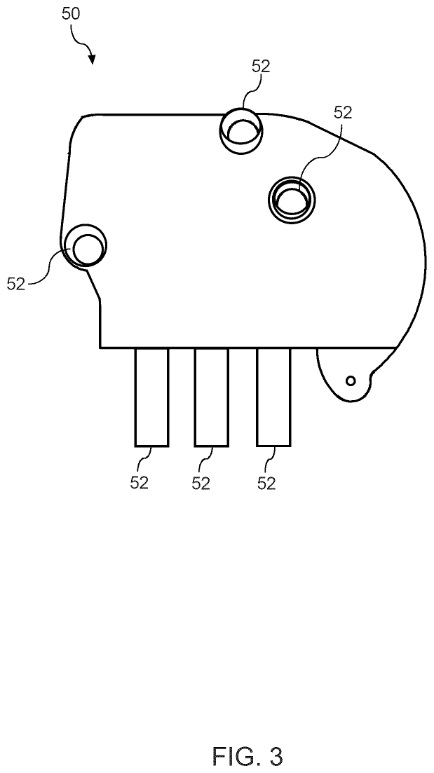

The polymer composition of the present disclosure can also be used to form a cooling fluid manifold 50 as shown in FIG. 3. The manifold 50 can be for connecting one tube with other tubes. For instance, the manifold 50 can include multiple inlets and outlets 52 and can be used to direct a cooling fluid to certain places within the cooling fluid system.

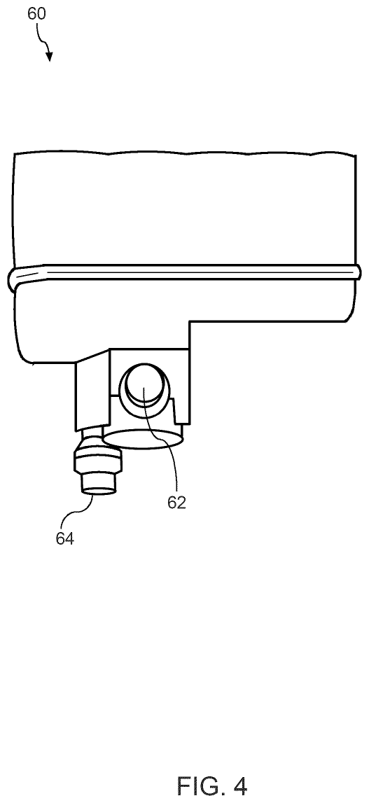

The polymer composition of the present disclosure can also be used to produce a cooling fluid tank 60 as shown in FIG. 4. The cooling fluid tank 60 can be a radiator tank or can be an expansion tank and can be in fluid communication with the cooling fluid circulation system. As shown in FIG. 4, the tank 60 can include a fluid inlet 62 and a fluid outlet 64 for receiving and releasing cooling fluids. In accordance with the present disclosure, the entire tank can be molded from the polymer composition.

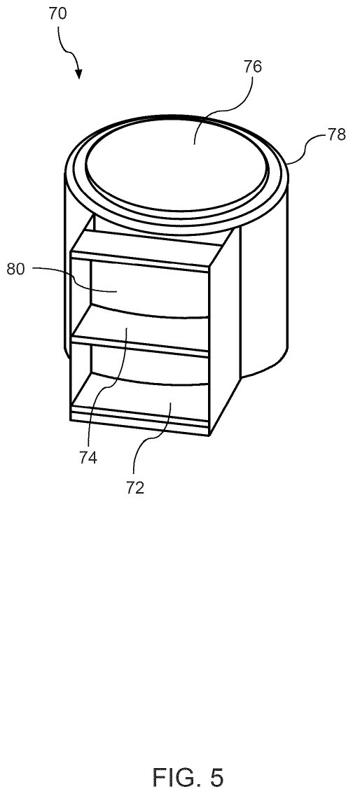

As described above, the cooling fluid system can include a plurality of valves that help direct cooling fluid based upon conditions within the system for maintaining the temperature of the battery packs within a preset temperature range. Referring to FIG. 5, one embodiment of a valve device 70 that can be used in the cooling fluid system is illustrated. The valve device 70 includes a fluid inlet 72 and a fluid outlet 74 that are in fluid communication with a valve component 76 that is contained within a housing 78. The polymer composition can be used to mold the inlet 72, the outlet 74, and the housing 78. The valve device 70 may also include various different movable slider parts 80 or components contained within the valve housing. The polymer composition is also well suited to producing all different types of movable parts that may also be in contact with the cooling fluid.

As described above, the polymer articles of the present disclosure can comprise molded polymer components defining at least a portion of a fluid flow pathway for a cooling fluid. The articles are formed from a polyamide polymer composition containing reinforcing fibers, such as glass fibers. In accordance with the present disclosure, the polyamide polymer contains a relatively high amount of amine end groups. The polymer composition can also contain a stabilizer comprising a copper complex and a crystallizing agent that lowers the crystallization temperature of the polyamide polymer.

The polyamide polymer forms a polymer matrix in the polymer composition and functions as a continuous phase of the composition.

Polyamides generally have a CO—NH linkage in the main chain and are obtained by condensation of a diamine and a dicarboxylic acid, by ring opening polymerization of lactam, or self-condensation of an amino carboxylic acid. For example, the polyamide may contain aliphatic repeating units derived from an aliphatic diamine, which typically has from 4 to 14 carbon atoms. Examples of such diamines include linear aliphatic alkylenediamines, such as 1,4-tetramethylenediamine, 1,6-hexanediamine, 1,7-heptanediamine, 1,8-octanediamine, 1,9-nonanediamine, 1,10-decanediamine, 1,11-undecanediamine, 1,12-dodecanediamine, etc.; branched aliphatic alkylenediamines, such as 2-methyl-1,5-pentanediamine, 3-methyl-1,5 pentanediamine, 2,2,4-trimethyl-1,6-hexanediamine, 2,4,4-trimethyl-1,6-hexanediamine, 2,4-dimethyl-1,6-hexanediamine, 2-methyl-1,8-octanediamine, 5-methyl-1,9-nonanediamine, etc.; as well as combinations thereof. Of course, aromatic and/or alicyclic diamines may also be employed. Furthermore, examples of the dicarboxylic acid component may include aromatic dicarboxylic acids (e.g., terephthalic acid, isophthalic acid, 2,6-naphthalenedicarboxylic acid, 2,7-naphthalenedicarboxylic acid, 1,4-naphthalenedicarboxylic acid, 1,4-phenylenedioxy-diacetic acid, 1,3-phenylenedioxy-diacetic acid, diphenic acid, 4,4′-oxydibenzoic acid, diphenylmethane-4,4′-dicarboxylic acid, diphenylsulfone-4,4′-dicarboxylic acid, 4,4′-biphenyldicarboxylic acid, etc.), aliphatic dicarboxylic acids (e.g., adipic acid, sebacic acid, etc.), and so forth. Examples of lactams include pyrrolidone, aminocaproic acid, caprolactam, undecanlactam, lauryl lactam, and so forth. Likewise, examples of amino carboxylic acids include amino fatty acids, which are compounds of the aforementioned lactams that have been ring opened by water.

In certain embodiments, an “aliphatic” polyamide is employed that is formed only from aliphatic monomer units (e.g., diamine and dicarboxylic acid monomer units). Particular examples of such aliphatic polyamides include, for instance, nylon-4 (poly-a-pyrrolidone), nylon-6 (polycaproamide), nylon-11 (polyundecanamide), nylon-12 (polydodecanamide), nylon-46 (polytetramethylene adipamide), nylon-66 (polyhexamethylene adipamide), nylon-610, and nylon-612. Nylon-6 and nylon-66 are particularly suitable. In one particular embodiment, for example, nylon-6 or nylon-66 may be used alone. In other embodiments, blends of nylon-6 and nylon-66 may be employed. When such a blend is employed, the weight ratio of nylon-6 to nylon-66 is typically from about 1:2 to about 1:8, such as from about 1:3 to about 1:6, such as from about 1:3 to about 1:5.

In one aspect, for instance, the polymer composition contains a nylon-66 polymer in an amount greater than about 30% by weight, such as in an amount greater than about 35% by weight, such as in an amount greater than about 40% by weight, such as in an amount greater than about 45% by weight, such as in an amount greater than about 50% by weight, such as in an amount greater than about 55% by weight, such as in an amount greater than about 60% by weight, such as in an amount greater than about 65% by weight, and in an amount less than about 90% by weight, such as in an amount less than about 85% by weight, such as in an amount less than about 80% by weight, such as in an amount less than about 75% by weight.

In accordance with the present disclosure, the polyamide polymer, such as the polyamide 66 polymer, contains a relatively high amount of amine end groups. For instance, the polyamide polymer can contain amine end groups in an amount greater than about 55 mmol/kg, such as in an amount greater than about 60 mmol/kg, such as in an amount greater than about 65 mmol/kg, such as in an amount greater than about 70 mmol/kg, such as in an amount greater than about 75 mmol/kg, such as in an amount greater than about 80 mmol/kg, and in an amount less than about 200 mmol/kg.

The polyamide polymer can have a melt flow rate of greater than about 30 g/10 min, such as greater than about 40 g/10 min, such as greater than about 50 g/10 min, such as greater than about 60 g/10 min, such as greater than about 70 g/10 min, such as greater than about 80 g/10 min, such as greater than about 85 g/10 min, and less than about 150 g/10 min, such as less than about 120 g/10 min. Melt flow is measured at a temperature of 275° C. and at a load of 2.16 kg when tested according to ISO Test 1133.

The nylon-66 polymer can be combined with a nylon-6 polymer. The nylon-6 polymer, in one aspect, can be present in the polymer composition in an amount greater than about 5% by weight, such as in an amount greater than about 8% by weight, and in an amount less than about 20% by weight, such as in an amount less than about 15% by weight, such as in an amount less than about 12% by weight.

It is also possible to include aromatic monomer units in the polyamide such that it is considered semi-aromatic (contains both aliphatic and aromatic monomer units) or wholly aromatic (contains only aromatic monomer units). For instance, suitable semi-aromatic polyamides may include poly(nonamethylene terephthalamide) (PA9T), poly(nonamethylene terephthalamide/nonamethylene decanediamide) (PA9T/910), poly(nonamethylene terephthalamide/nonamethylene dodecanediamide) (PA9T/912), poly(nonamethylene terephthalamide/11-aminoundecanamide) (PA9T/11), poly(nonamethylene terephthalamide/12-aminododecanamide) (PA9T/12), poly(decamethylene terephthalamide/11-aminoundecanamide) (PA10T/11), poly(decamethylene terephthalamide/12-aminododecanamide) (PA10T/12), poly(decamethylene terephthalamide/decamethylene decanediamide) (PA10T/1010), poly(decamethylene terephthalamide/decamethylene dodecanediamide) (PA10T/1012), poly(decamethylene terephthalamide/tetramethylene hexanediamide) (PA10T/46), poly(decamethylene terephthalamide/caprolactam) (PA10T/6), poly(decamethylene terephthalamide/hexamethylene hexanediamide) (PA10T/66), poly(dodecamethylene terephthalamide/dodecamethylene dodecanediarnide) (PA12T/1212), poly(dodecamethylene terephthalamide/caprolactam) (PA12T/6), poly(dodecamethylene terephthalamide/hexamethylene hexanediamide) (PA12T/66), and so forth.

In one embodiment, the polymer composition contains primarily or only aliphatic polyamide polymers that may be blended with one or more semi-aromatic polyamide polymers or a wholly aromatic polyamide polymer. In other embodiments, the polymer composition may only contain semi-aromatic polyamide polymers, may only contain wholly aromatic polyamide polymers, or may only contain a combination of semi-aromatic polyamide polymers and wholly aromatic polyamide polymers.

The polyamide employed in the polymer composition is typically crystalline or semi-crystalline in nature and thus has a measurable melting temperature. The melting temperature may be relatively high such that the composition can provide a substantial degree of heat resistance to a resulting part. For example, the polyamide may have a melting temperature of about 220° C. or more, in some embodiments from about 240° C. to about 325° C., and in some embodiments, from about 250° C. to about 335° C. The polyamide may also have a relatively high glass transition temperature, such as about 30° C. or more, in some embodiments about 40° C. or more, and in some embodiments, from about 45° C. to about 140° C. The glass transition and melting temperatures may be determined as is well known in the art using differential scanning calorimetry (“DSC”), such as determined by ISO Test No. 11357-2:2013 (glass transition) and 11357-3:2011 (melting).

In accordance with the present disclosure, the polyamide polymer containing a relatively high amount of amine end groups is combined with reinforcing fibers, which can comprise inorganic fibers.

Inorganic fibers can be employed in the polymer composition to improve the thermal and mechanical properties of the composition. The inorganic fibers typically have a high degree of tensile strength relative to their mass. For example, the ultimate tensile strength of the fibers (determined in accordance with ASTM D822/D822M-13 (2018)) is typically from about 1,000 to about 15,000 Megapascals (“MPa”), in some embodiments from about 2,000 MPa to about 10,000 MPa, and in some embodiments, from about 3,000 MPa to about 6,000 MPa. Further, although the fibers may have a variety of different sizes, fibers having a certain size can help improve the mechanical properties of the resulting polymer composition. The inorganic fibers may, for example, have a nominal diameter of from about 5 micrometers to about 40 micrometers, in some embodiments from about 6 micrometers to about 30 micrometers, in some embodiments from about 8 micrometers to about 20 micrometers, and in some embodiments from about 9 micrometers to about 15 micrometers. The fibers (after compounding) may also have a relatively high aspect ratio (average length (μm) divided by nominal diameter (μm)), such as about 2 or more, in some embodiments from about 4 to about 100, in some embodiments from about 5 to about 50, and in some embodiments, from about 8 to about 40 are particularly beneficial. Such fibers may, for instance, have a volume average length (after compounding) of about 10 micrometers or more, in some embodiments about 25 micrometers or more, in some embodiments from about 50 micrometers or more to about 800 micrometers or less, and in some embodiments from about 60 micrometers to about 500 micrometers.

In addition to the size, strength, and relative concentration, the composition of the inorganic fibers may also be selectively controlled to achieve better hydrolytic stability at high temperatures. Generally speaking, the inorganic fibers may be formed from materials that are generally insulative in nature, such as glass, ceramics (e.g., alumina or silica), etc. Glass fibers are particularly suitable, such as E-glass, E-CR glass, A-glass, C-glass, D-glass, AR-glass, R-glass, S1-glass, S2-glass, etc., as well as mixtures of any of the foregoing. Glass fibers that are generally free of boron (e.g., E-CR glass fibers) are particularly suitable. In certain embodiments, the glass fibers may include silica (SiO₂), alumina (Al₂O₃), and oxides of calcium and magnesium (e.g., CaO, MgO, etc.), but are generally free of boron and optionally fluorides. For example, the glass fibers may contain boron in a concentration of about 1 wt. % or less, in some embodiments about 0.5 wt. % or less, in some embodiment about 0.1 wt. % or less (e.g., 0 wt. %), relative to the total weight of the glass fibers. The glass fibers may likewise contain fluorides in a concentration of about 0.5 wt. % or less, in some embodiments about 0.2 wt. % or less, in some embodiment about 0.01 wt. % or less (e.g., 0 wt. %), relative to the total weight of the glass fibers. Boron concentration and fluoride concentration can be measured by inductively coupled plasma-atomic emission spectrometry. In the absence of boric oxide, the glass fibers may further include titanium dioxide (TiO₂) to reduce melt viscosity. For example, the concentration of titanium in the glass fibers may be about 0.1 wt. % to about 1 wt. %, and in some embodiments, from about 0.15 wt. % to about 0.5 wt. % of the total weight of the glass fibers. Besides titanium dioxide, the glass fibers can further include potassium oxide (K₂O) and/or lithium oxide (Li₂O) as fluxing agents. For example, the concentration of potassium in the glass fibers may be about 0.2 wt. % to about 1 wt. %, and in some embodiments, from about 0.3 wt. % to about 0.5 wt. % of the total weight of the glass fibers. The concentration of lithium in the glass fibers may also be about 0.1 wt. % to about 1 wt. %, and in some embodiments, from about 0.2 wt. % to about 0.5 wt. % of the total weight of the glass fibers. The glass fibers may also have a relatively low amount of sodium oxide (Na₂O). For example, the concentration of sodium in the glass fibers may be about 0.1 wt. % to about 1 wt. %, and in some embodiments, from about 0.2 wt. % to about 0.5 wt. % of the total weight of the glass fibers. Titanium, potassium, lithium, and sodium concentrations can be measured by ICP-AES. In one particular embodiment, the glass fibers may contain silica in an amount of from about 57.5 wt. % to about 59.5 wt. %, alumina in an amount of from about 17 wt. % to about 20 wt. %, calcium oxide in an amount of from about 11 wt. % to about 13.5 wt. %, magnesium oxide in an amount of from about 8.5 wt. % to about 12.5 wt. %, and optionally sodium oxide, potassium oxide, lithium oxide, and/or titanium oxide. Other oxides may also be employed, such as iron oxide (Fe₂O₃).

If desired, the inorganic fibers may contain a sizing composition coated thereon to help improve hydrolytic resistance. The sizing composition may include an organosilane compound that is capable of forming Si—O—Si covalent bonds between the glass fiber surface and silanols obtained by hydrolysis of the silane compound, as well as between adjacent silanol groups. The resulting covalent bonds forms a crosslinked structure at the surface of the fibers that can enhance resistance to hydrolysis. Such organosilane compounds may, for instance, constitute from about 2 wt. % to about 40 wt. %, in some embodiments from about 2.5 wt. % to about 20 wt. %, and in some embodiments, from about 5 wt. % to about 15 wt. % of the solids content of the sizing composition (i.e., excluding water). The organosilane compound may, for example, be any alkoxysilane as is known in the art, such as vinlyalkoxysilanes, epoxyalkoxysilanes, aminoalkoxysilanes, mercaptoalkoxysilanes, and combinations thereof. In one embodiment, for instance, the organosilane compound may have the following general formula:

R⁵—Si—(R⁶)₃,

wherein,
R⁵ is a sulfide group (e.g., —SH), an alkyl sulfide containing from 1 to 10 carbon atoms (e.g., mercaptopropyl, mercaptoethyl, mercaptobutyl, etc.), alkenyl sulfide containing from 2 to 10 carbon atoms, alkynyl sulfide containing from 2 to 10 carbon atoms, amino group (e.g., NH₂), aminoalkyl containing from 1 to 10 carbon atoms (e.g., aminomethyl, aminoethyl, aminopropyl, aminobutyl, etc.); aminoalkenyl containing from 2 to 10 carbon atoms, aminoalkynyl containing from 2 to 10 carbon atoms, and so forth;
R⁶ is an alkoxy group of from 1 to 10 carbon atoms, such as methoxy, ethoxy, propoxy, and so forth.

Aminosilane compounds are particularly suitable and may include monomeric or oligomeric (<6 units) silanes. Aminotrialkoxysilanes may be employed in certain embodiments to form a three dimensional network of Si—O—Si covalent bonds at the surface and around the surface of the fibers. Aminodialkoxysilanes may likewise be employed in certain embodiments to form a hairlike structure on the surface of the fibers. While not necessarily forming a three-dimensional crosslinked protective sheath around the fibers, the dialkoxysilanes may nevertheless facilitate impregnation of the fiber bundles and wetting of the individual fibers by a polymer melt, as well as reduce the hydrophilicity of the surface of the fibers believed to contribute to resistance to hydrolysis. Thus, it may be desirable to employ trialkoxysilanes, dialkoxysilanes, or mixtures thereof in the sizing composition. Specific examples of suitable aminosilanes may include, for instance, aminodialkoxysilanes, such as γ-aminopropylmethyldiethoxysilane, N-β-(Aminoethyl)-gamma-aminopropylmethyldimethoxysilane, N-β-(Aminoethyl)-γ-aminopropyl-methyldimethoxysilane, N-β-(Aminoethyl)-γ-aminoisobutylmethyldimethoxy-silane, γ-aminopropylmethyldimethoxysilane, N-β-(Aminoethyl)-γ-aminopropyl-methyldiethoxysilane, etc.; aminotrialkoxysilanes, such as γ-aminopropyltriethoxysilane, γ-aminopropyltri-methoxysilane, N-β-(Aminoethyl)-γ-aminopropyl-trimethoxysilane, N-β-(Aminoethyl)-γ-aminopropyltriethoxysilane, diethylene-triaminopropyltrimethoxysilane, Bis-(γ-trimethoxysilylpropyl)amine, N-phenyl-γ-aminopropyltrimethoxysilane, γ-amino-3,3-dimethylbutyltrimethoxysilane, γ-aminobutyltriethoxysilane, etc.; as well as mixtures of any of the foregoing.

In addition to an organosilane compound, the sizing composition may also contain one or more functionalized compounds that may be crosslinked to form a three-dimensional polymer network that can further enhance the hydrolytic resistance of the fibers. When employed, such functionalized compounds may constitute from about 5 wt. % to about 90 wt. %, in some embodiments from about 10 wt. % to about 80 wt. %, and in some embodiments, from about 15 wt. % to about 70 wt. % of the solids content of the sizing composition (i.e., excluding water). In one embodiment, for instance, the functionalized compound may be a blocked isocyanate. As used herein, the term “blocked isocyanate” refers to an isocyanate in which one or more of the isocyanate groups of an organic polyisocyanate have been reversibly reacted with a blocking agent. In this manner, the resulting blocked (partially or fully) isocyanate groups are stable to active hydrogens at ambient temperature but can become deblocked at elevated temperatures so that they are reactive with active hydrogens, such as, for example, at temperatures between about 90° C. to about 210° C., in some embodiments between about 105° C. to about 180° C., and in some embodiments, between about 125° C. to about 170° C. Representative examples of suitable organic polyisocyanates include aliphatic isocyanates (e.g., trimethylene diisocyanate, tetramethylene diisocyanate, hexamethylene diisocyanate, butylidene diisocyanate, etc.); (cyclo) aliphatic isocyanates (e.g., isophorone diisocyanate (IPDI), 4,4′-diisocyanato-dicyclohexylmethane (HMDI), etc.); aromatic isocyanates (e.g., p-phenylene diisocyanate); aliphatic-aromatic isocyanates (e.g., 4,4′-diphenylene methane diisocyanate, 2,4- or 2,6-tolylene diisocyanate, etc.); as well as mixtures thereof. Representative examples of suitable blocking agents include, but are not limited to, oximes, such as methyl ethyl ketoxime, acetone oxime and cyclohexanone oxime; lactams, such as epsilon-caprolactam; alcohols; malonic esters; alkyl acetoacetates, triazoles; pyrazoles; phenols; amines, such as benzyl t-butylamine; as well as mixtures thereof. In one embodiment, the blocked isocyanate is a blocked cycloaliphatic polyisocyanate.

The functionalized compound may also include polymers that contain an anhydride and/or carboxylic functionality. Examples of such polymers may include, for instance, a copolymer of ethylene-maleic anhydride, butadiene-maleic anhydride, isobutylene-maleic anhydride acrylate-maleic anhydride, polyacrylic acid, etc. When employed, such anhydride- and/or carboxylic-functionalized polymers may constitute from about 5 wt. % to about 60 wt. %, in some embodiments from about 10 wt. % to about 40 wt. %, and in some embodiments, from about 15 wt. % to about 30 wt. % of the solids content of the sizing composition (i.e., excluding water). Other functionalized polymers may also be employed, either alone or in combination with polymers that contain an anhydride and/or carboxylic functionality. In certain embodiments, for example, an epoxy-functionalized polymer may be employed, such as epoxy phenol novolac (EPN), epoxy cresol novolac (ECN), etc. When employed, such epoxy-functionalized polymers may constitute from about 30 wt. % to about 90 wt. %, in some embodiments from about 40 wt. % to about 80 wt. %, and in some embodiments, from about 50 wt. % to about 70 wt. % of the solids content of the sizing composition (i.e., excluding water). In certain embodiments, combinations of such functionalized polymers may also be employed. In fact, it is believed that a dense crosslinked sheath can formed around the inorganic fibers by reaction of epoxy groups with maleic anhydride and/or carboxylic groups.

Apart from organosilane and functionalized compounds, the sizing composition may also contain a film-forming agent that can help protect the fibers from damage during processing and promote compatibility of the fibers with the polymer matrix. Particularly suitable film forming agents are polymers, such as polyurethanes, (meth)acrylate polymers, epoxy resin emulsions (e.g., based on epoxy bisphenol A or epoxy bisphenol F), epoxy ester resins, epoxy urethane resins, polyamides, etc., as well as mixtures of any of the foregoing. In one particular embodiment, for example, the film forming agent may include a polymer that is also functionalized, such as a polymer that includes a blocked isocyanate functionality as described above. Examples of such functionalized film-forming agents may include polyester-based and polyether-based polyurethanes that include a blocked isocyanate. When employed, such film forming agents may constitute from about 0.1 wt. % to about 50 wt. %, in some embodiments from about 1 wt. % to about 40 wt. %, and in some embodiments, from about 5 wt. % to about 30 wt. % of the solids content of the sizing composition (i.e., excluding water). Other additives may also be employed in the sizing composition, such as pH adjusters, lubricants, antistatic agents, antifoaming agents, crosslinking agents, etc.

The sizing composition may be applied to the surface of the inorganic fibers in a variety of different ways. For example, the sizing composition may be applied as the fibers are formed out of a bushing. The entire composition may also be applied to the fibers in a single step, or one or more components of the sizing composition may be applied separately. In one embodiment, for example, a two-stage application process may be employed in which a polymer containing an anhydride and/or carboxylic acid functionality is applied in a first stage and a polymer containing an epoxy functionality is applied in a second stage. In this manner, the polymers may be crosslinked together only after application to the fiber surface. Other components of the sizing composition may be applied separately or in combination with one or both of the polymers. Notwithstanding the particular process employed, one or more solvents (e.g., water) may be added to the components of the sizing composition during application to aid in the coating process. Once coated, the fibers may be dried to remove the solvent. In this regard, the moisture content of the coated fibers is typically about 0.5 wt. % or less, in some embodiments about 0.2 wt. % or less, and in some embodiments about 0.1 wt. % or less. Likewise, the amount of the sizing composition employed is typically from about 0.3 wt. % to about 1.2 wt. %, in some embodiments from about 0.4 wt. % to about 1 wt. %, and in some embodiments, from about 0.5 wt. % to about 0.8 wt. % based on the total weight of the coated fibers.

The reinforcing fibers can be present in the polymer composition generally in an amount from about 5% by weight to about 55% by weight. For instance, the reinforcing fibers can be present in the polymer composition in an amount greater than about 10% by weight, such as in an amount greater than about 15% by weight, such as in an amount greater than about 20% by weight, such as in an amount greater than about 25% by weight, and in an amount less than about 40% by weight, such as in an amount less than about 35% by weight.

The composition can also contain a heat stabilizer. In one embodiment, for instance, the heat stabilizer can comprise iodobis(triphenylphosphino) copper. Alternatively, the heat stabilizer can be a metal halide, such as a metal iodide. The metal iodide can be a potassium iodide, a copper iodide, or mixtures thereof.

In one aspect, the heat stabilizer can include a copper compound that can include a copper (I) salt, copper (II) salt, copper complex, or a combination thereof. For example, the copper (I) salt may be Cul, CuBr, CuCl, CuCN, CU₂O, or a combination thereof and/or the copper (II) salt may be copper acetate, copper stearate, copper sulfate, copper propionate, copper butyrate, copper lactate, copper benzoate, copper nitrate, CuO, CuCl₂, or a combination thereof. In certain embodiments, the copper compound may be a copper complex that contains an organic ligand, such as alkyl phosphines, such as trialkylphosphines (e.g., tris-(n-butyl)phosphine) and/or dialkylphosphines (e.g., 2-bis-(dimethylphosphino)-ethane); aromatic phosphines, such as triarylphosphines (e.g., triphenylphosphine or substituted triphenylphosphine) and/or diarylphosphines (e.g., 1,6-(bis-(diphenylphosphino))-hexane, 1,5-bis-(diphenylphosphino)-pentane, bis-(diphenylphosphino) methane, 1,2-bis-(diphenylphosphino) ethane, 1,3-bis-(diphenylphosphino) propane, 1,4-bis-(diphenylphosphino) butane, etc.); mercaptobenzimidazoles; glycines; oxalates; pyridines (e.g., bypyridines); amines (e.g., ethylenediaminetetraacetates, diethylenetriamines, triethylenetetramines, etc.); acetylacetonates; and so forth, as well as combinations of the foregoing. Particularly suitable copper complexes for use in the heat stabilizer may include, for instance, copper acetylacetonate, copper oxalate, copper EDTA, [Cu(PPh₃)₃X], [Cu₂X(PPH₃)₃], [Cu(PPh₃)X], [Cu(PPh₃)₂X], [CuX(PPh₃)-2,2′-bypyridine], [CuX(PPh₃)-2,2′-biquinoline)], or a combination thereof, wherein PPh₃ is triphenylphosphine and X is CI, Br, I, CN, SCN, or 2-mercaptobenzimidazole. Other suitable complexes may likewise include 1,10-phenanthroline, o-phenylenebis(dimethylarsine), 1,2-bis(diphenylphosphino)-ethane, terpyridyl, and so forth.

When employed, the copper complexes may be formed by reaction of copper ions (e.g., copper (I) ions) with the organic ligand compound (e.g., triphenylphosphine or mercaptobenzimidazole compounds). For example, these complexes can be obtained by reacting triphenylphosphine with a copper (I) halide suspended in chloroform (G. Kosta, E. Reisenhofer and L. Stafani, J. Inorg. Nukl. Chem. 27 (1965)2581). However, it is also possible to reductively react copper (II) compounds with triphenylphosphine to obtain the copper (I) addition compounds (F. U. Jardine, L. Rule, A. G. Vohrei, J. Chem. Soc. (A)238-241 (1970)). However, the complexes used according to the invention can also be produced by any other suitable process. Suitable copper compounds for the preparation of these complexes are the copper (I) or copper (II) salts of the hydrogen halide acids, the hydrocyanic acid or the copper salts of the aliphatic carboxylic acids. Examples of suitable copper salts are copper (I) chloride, copper (I) bromide, copper (I) iodide, copper (I) cyanide, copper (II) chloride, copper (II) acetate, copper (II) stearate, etc., as well as combinations thereof.

In one embodiment, the copper-based stabilizer can comprise a copper and organic halogen complex. For instance, the stabilizer can comprise a complex of copper, di-u-iodotris(triphenylphosphine)di- and iodobis(triphenylphosphino) copper.

The stabilizer may also contain a halogen-containing synergist. When employed, the copper compound and halogen-containing synergist are typically used in quantities to provide a copper: halogen molar ratio of from about 1:1 to about 1:50, in some embodiments from about 1:4 to about 1:20, and in some embodiments, from about 1:6 to about 1:15. For example, the halogen content of the polymer composition may be from about 1 ppm to about 10,000 ppm, in some embodiments from about 50 ppm to about 5,000 ppm, in some embodiments from about 100 ppm to about 2,000 ppm, and in some embodiments, from about 300 ppm to about 1,500 ppm. In one aspect, the halogen content of the polymer composition is less than about 1000 ppm, such as less than about 600 ppm, such as less than about 500 ppm, such as less than about 400 ppm.

The halogenated synergist generally includes an organic halogen-containing compound, such as aromatic and/or aliphatic halogen-containing phosphates, aromatic and/or aliphatic halogen-containing hydrocarbons; and so forth, as well as combinations thereof. For example, suitable halogen-containing aliphatic phosphates may include tris(halohydrocarbyl)-phosphates and/or phosphonate esters. Tris(bromohydrocarbyl) phosphates (brominated aliphatic phosphates) are particularly suitable. In particular, in these compounds, no hydrogen atoms are attached to an alkyl C atom which is in the alpha position to a C atom attached to a halogen. This minimizes the extent that a dehydrohalogenation reaction can occur which further enhances stability of the polymer composition. Specific exemplary compounds are tris(3-bromo-2,2-bis(bromomethyl) propyl)phosphate, tris(dibromoneopentyl)phosphate, tris(trichloroneopentyl)phosphate, tris(bromodichlorneopentyl)phosphate, tris(chlordibromoneopentyl)phosphate, tris(tribromoneopentyl)phosphate, or a combination thereof. Suitable halogen-containing aromatic hydrocarbons may include halogenated aromatic polymers (including oligomers), such as brominated styrene polymers (e.g., polydibromostyrene, polytribromostyrene, etc.); halogenated aromatic monomers, such as brominated phenols (e.g., tetrabromobisphenol-A); and so forth, as well as combinations thereof.

The stabilizer can be present in the polymer composition generally in an amount greater than about 0.0001% by weight, such as in an amount greater than about 0.08% by weight, such as in an amount greater than about 0.1% by weight, such as in an amount greater than about 0.2% by weight, such as in an amount greater than about 0.3% by weight, such as in an amount greater than about 0.4% by weight, such as in an amount greater than about 0.5% by weight, such as in an amount greater than about 0.6% by weight, such as in an amount greater than about 0.7% by weight, such as in an amount greater than about 0.8% by weight, and generally in an amount less than about 3% by weight, such as in an amount less than about 2.5% by weight, such as in an amount less than about 2% by weight, such as in an amount less than about 1.5% by weight, such as in an amount less than about 1.3% by weight.

In one embodiment, the polymer composition can also contain a crystallizing agent that lowers the crystallization temperature of the polyamide polymer. The crystallizing temperature of a thermoplastic polymer, for instance, can be detected using differential scanning calorimetry (DSC).

In one aspect, the crystallizing agent can comprise a polymer, such as a copolymer. Alternatively, the crystallizing agent can serve a dual purpose by not only lowering the crystallization temperature of the polyamide polymer but also acting as a coloring agent. For instance, in one aspect, the crystallizing agent can comprise an azine dye. The azine dye, for instance, can comprise an induline and/or a nigrosine. For instance, in one aspect, the crystallizing agent can comprise a black coloring agent comprising a nigrosine.

Examples of nigrosine are a black azine-type condensed mixture such as C. I. Solvent Black 5 and C. I. Solvent Black 7 described in Color Index. The nigrosine can be synthesized by reaction of oxidation and dehydrating condensation of aniline, aniline hydrochloride and nitrobenzene at 160° C. or 180° C. as reaction temperature under the existence of iron chloride.

The crystallizing agent can be present in the polymer composition such that the crystallization temperature of the polyamide polymer is less than about 225° C., such as less than about 223° C., such as less than about 221° C., and greater than about 200° C., such as greater than about 210° C., such as greater than about 215° C. For instance, the crystallizing agent can be present in the polymer composition in an amount greater than about 0.1% by weight, such as in an amount greater than about 0.3% by weight, such as in an amount greater than about 0.5% by weight, such as in an amount greater than about 0.7% by weight, such as in an amount greater than about 0.9% by weight. The crystallizing agent can be present in an amount less than about 5% by weight, such as in an amount less than about 2% by weight, such as in an amount less than about 1.7% by weight.

In one aspect, a lubricant can be present in the polymer composition. Any suitable lubricant can be incorporated into the polymer composition. In one aspect, the lubricant can comprise a partially saponified ester wax. For example, the lubricant can comprise a partially saponified ester wax of a C22 to C36 fatty acid. The fatty acid, for instance, can comprise a montan wax. In one aspect, the lubricant can contain 1-methyl-1,3-propanediyl esters. In another aspect, the lubricant can be a fatty acid amide, including fatty primary amides, fatty secondary amides, and the like. Other suitable lubricants include metal salts of fatty acids, such as calcium stearate, aluminum distearate, zinc stearate, magnesium stearate, and mixtures thereof. The lubricant can be present in the polymer composition generally in an amount greater than about 0.08% by weight, such as in an amount greater than about 0.1% by weight, such as in an amount greater than about 0.2% by weight, such as in an amount greater than about 0.3% by weight, such as in an amount greater than about 0.4% by weight, and generally in an amount less than about 3% by weight, such as in an amount less than about 2.5% by weight, such as in an amount less than about 2% by weight, such as in an amount less than about 1.5% by weight, such as in an amount less than about 1% by weight, such as in an amount less than about 0.8% by weight.

The polymer composition can also contain a nucleating agent. The nucleating agent can comprise one or more polymers, such as copolymers, or may comprise inorganic or organic particles. For instance, the nucleating agent can comprise calcium carbonate, talc, or the like. Alternatively, the nucleating agent can comprise an ethylene-acrylic acid copolymer or a condensation product formed from an isocyanic ester of cyclohexyl or phenyl and an alcohol, phenol, acid, or the like. One or more nucleating agents can be present in the polymer composition in an amount greater than about 0.05% by weight, such as in an amount greater than about 0.08% by weight, such as in an amount greater than about 0.1% by weight, and in an amount less than about 2% by weight, such as in an amount less than about 1% by weight, such as in an amount less than about 0.8% by weight.

In one embodiment, a lubricant and a nucleating agent can be compounded together and added to the polymer composition. The compounded product can comprise a mixture of copolymers and montanic acid derivatives. In addition, an antioxidant can be added to the compounded product. The antioxidant can comprise an inorganic phosphate.

The composition can optionally include a light stabilizer which may comprise a hindered amine light stabilizer. Examples of light stabilizers that may be incorporated into the present disclosure include a benzendicarboxamide. The light stabilizer may also comprise any compound which is derived from an alkylsubtituted piperidyl, piperidinyl or piperazinone compound or a substituted alkoxypiperidinyl. Other suitable HALS are those that are derivatives of 2,2, 6,6-tetramethyl piperidine. Preferred specific examples of HALS include: ˜2,2, 6,6-tetramethyl-4-piperidinone, ˜2,2, 6,6-tetramethyl-4-piperidinol, ˜bis-(2, 2, 6,6-tetramethyl-4-piperidinyl)-sebacate, ˜mixtures of esters of 2,2,6,6-tetramethyl-4-piperidinol and fatty acids, ˜bis-(2,2,6,6-tetramethyl-4-piperidinyl)-succinate, ˜bis-(1-octyloxy-2,2,6,6-tetramethyl-4-piperidinyl)-sebacate, ˜bis-(1,2,2,6,6-pentamethyl-4-piperidinyl)-sebacate, ˜tetrakis-(2,2,6,6-tetramethyl-4-piperidyl)-1,2,3,4-butane-tetracarboxylate, ˜N-butyl-2,2,6,6-tetramethyl-4-piperidinamine, ˜N,N′-bis-(2,2,6,6-tetramethyl-4-piperidyl)-hexane-1,6-diamine, ˜2.2′-[(2.2.6.6-tetramethyl-4-piperidinyl)-imino]-bis-[ethanol], ˜5-(2.2.6.6-tetramethyl-4-piperidinyl)-2-cyclo-undecyl-oxazole), ˜mixture of: 2,2,4,4 tetramethyl-21-oxo-7-oxa-3.20-diazadispiro[5.1.11.2] heneicosane-20-propionic acid dodecylester and 2.2.4.4 tetramethyl-21-oxo-7; oxa-3,20-diazadispiro[5,1,11,2]-heneicosane-20-propionic acid; tetradecyl ester, ˜diacetam 5 (CAS registration number: 76505-58-3), ˜propanedioic acid, [(4-methoxyphenyl)methylene]-, bis(1,2,2,6,6-pentamethyl-4-piperidinyl) ester, ˜1,3-benzendicarboxamide, N,N′-bis(2,2,6,6-tetramethyl-4-piperidinyl), ˜3-dodecyl-1-(2,2,6,6-tetramethyl-4-piperidyl)-pyrrolidin-2,5-dione, ˜formamide, N,N′-1,6-hexanediylbis[N-(2,2,6,6-tetramethyl-4-piperidinyl, ˜3-dodecyl-1-(1,2,2, 6,6-pentamethyl-4-piperidyl)-pyrrolidin-2,5-dione, ˜1,5-Dioxaspiro(5,5) undecane 3,3-dicarboxylic acid, bis(2,2,6,6-tetramethyl-4-peridinyl) ester, ˜1,5-Dioxaspiro(5,5) undecane 3,3-dicarboxylic acid, bis(1,2,2,6,6-pentamethyl-4-peridinyl) ester, ˜bis(1,2,2,6,6-penta methyl-4-piperidyl) (3,5-di-t-butyl-4-hydroxybenzyl)-butylpropanedioate, ˜tetrakis-(1,2,2,6,6-penta-methyl-4-piperidyl)-1,2,3,4-butane-tetra--carboxylate, ˜1,2,3,4-butanetetracarboxylic acid, tetrakis(2,2,6,6-tetramethyl-4-piperidinyl) ester, ˜1,2,3,4-butane-tetracarboxylic acid-1,2,3-tris(1,2,2,6,6-pentamethyl-4-piperidinyl)-4-tridecylester, ˜8-acetyl-3-dodecyl-7,7,9,9-tetra methyl-1,3,8-triazaspiro(4,5) decane-2,4-dione, ˜N-2,2,6,6-tetrametyl-4-piperidinyl-N-amino-oxamide, ˜4-acryloyloxy-1,2,2,6,6-pentamethyl-4-piperidine, ˜1,5,8,12-tetrakis[2′,4′-bis(1″,2″,2″,6″,6″-pentamethyl-4″-piperidinyl(butyl) amino)-1′,3′,5′-tr-iazin-6′-yl]-1,5,8,12-tetraazadodecane, ˜1,1′-(1,2-ethane-di-yl)-bis-(3,3′, 5,5′-tetra-methyl-piperazinone) (Good rite 3034), ˜propane amide, 2-methyl-N-(2,2,6,6-tetramethyl-4-piperidinyl)-2-[(2,2,6,6-tetramethyl-4-piperidinyl)amino], ˜oligomer of N-(2-hydroxyethyl)-2,2,6,6-tetramethyl-4-piperidinol and succinic acid, ˜poly[6-[(1,1,3,3-tetramethylbutyl)amino]-s-triazine-2,4-diyl] [2,2,6,6-tetram-ethyl-4-piperidinyl)imino] hexamethylene[(2,2,6,6-tetramethyl-4-piperidinyl)imino]], ˜poly[(6-morfoline-S-triazine-2.4-diyl) [(2.2.6.6-tetramethyl-4-piperidinyl)-imino] hexamethylene-[(2.2.6.6-tetram-ethyl-4-piperidinyl)-imino]], ˜ poly[(6-morpholino-s-triazine-2.4-diyl) [1.2.2.6.6-penta-methyl-4-piperidyl)imino]-hexamethylene[(2,2,6,6 tetra-methyl-4-piperidyl)imino]], ˜poly methylpropyl-3-oxy-[4 (2.2.6.6-tetrametyl)-piperidinyl)]-siloxane copolymer of a-methylstyrene and n-(2.2.6.6-tetramethyl-piperidinyl)-4-maleimide and N-stearyl-maleimide, ˜1,2,3,4-butane tetracarboxylic acid, polymer with 8,8,8′,8′-tetramethyl-2,4,8,10-tetraoxaspiro[5,5] undecane-3,9-diethanol, 1,2,2, 6,6-pentamethyl-4-piperidinyl ester, ˜1,2, 3,4-butanetetracarboxylic acid, polymer with 8,8,8′,8′-tetramethyl-2,4,8, 10-tetraoxaspiro[5,5] undecane-3,9-diethanol, 2,2,6,6-tetramethyl-4-piperidinyl ester, ˜oligomer of 7-Oxa-3,20-diazadispiro[5,1, 11,2] heneicosan-21-one, 2,2,4,4-tetramethyl-20-(oxiranylmethyl), ˜1,3,5-Triazine-2,4,6-triamine, N, N″-[1,2-ethanediylbis[[4,6-bis[butyl(1,2,2,6,6-pentamethyl-4-iperidinyl)amino]-1, 3,5-triazine--2-yl] imino]-3, 1-propanediyl]]-bis[N. N″-dibutyl-N. N″-bis(1.2.2.6.6-pentamethyl-4-piperidinyl), ˜1.3-Propanediamine, N, N-1,2-ethanediylbis-, polymer with 2,4,6-trichloro-1,3,5-triazine, reaction products with N-butyl-2,2,6,6-tetramethyl-4-piperidinamine, ˜1.6-Hexanediamine, N,N′-bis(2,2,6,6-tetramethyl-4piperidinyl)-polymer with 2,4,6-trichloro-1,3,5-triazine, reaction products with N-butyl-1-butanamine and N-butyl-2,2,6,6-tetramethyl-4-piperidinamine, ˜2,9,11,13,15,22,24,26,27,28-Decaazatricyclo[21,3,1,110,14] octacosa-1 (27), 10,12,14 (28),23,25-hexaene-12, 25-diamine, N,N′-bis(1,1,3,3-tetramethylbutyl)-2,9, 15,22-tetrakis(2,2,6,6-tetramethyl-4-piperidinyl)-, ˜1,1,1″-(1,3,5-Triazine-2,4,6-triyltris((cyclohexylimino)-2,1-ethanediyl)tris(3,3,5,5-tetramethylpiperazinone), ˜1,1,1″-(1,3,5-Triazine-2,4,6-triyltris((cyclohexylimino)-2,1-ethylenediyl)tris(3,3,4,5,5-tetramethylpiperazinone), ˜1,6-hexanediamine, N,N′-bis(2,2,6,6-tetramethyl-4-piperidinyl)-, polymer with 2,4,6-trichloro-1,3,5-triazine, reaction products with 3-bromo-1-propene, nbutyl-1-butanamine and N-butyl-2,2,6,6-tetramethyl-4-piperidinamine, oxidised, hydrogenated, ˜Alkenes, (C20-24)-4 alpha-, polymers with maleic anhydride, reaction products with 2,2,6,6-tetramethyl-4-piperidinamine, ˜N-2,2,6,6-tetramethyl-4-piperidinyl-N-amino-oxamide; 4-acryloyloxy-1,2,2,6,6-pentamethyl-4-piperidine; HALS PB-41 or mixtures thereof.

One or more light stabilizers can generally be present in the composition in an amount greater than about 0.01% by weight, such as in an amount greater than about 0.05% by weight, such as in an amount greater than about 0.08% by weight, and generally in an amount less than about 2% by weight, such as in an amount less than about 1% by weight, such as in an amount less than about 0.8% by weight, such as in an amount less than about 0.5% by weight, such as in an amount less than about 0.3% by weight, such as in an amount less than about 0.2% by weight.

Polymer compositions formulated in accordance with the present disclosure have many applications and uses. As described above, the polymer composition is particularly well suited for contact with a cooling fluid. Shaped parts and articles can be made using any suitable process. For instance, suitable techniques include injection molding, blow molding, compression molding, extrusion molding, and the like.

The present disclosure may be better understood with reference to the following examples.

### Example No. 1

A polymer composition was formulated in accordance with the present disclosure and tested for mechanical properties after exposure to a cooling fluid. The following composition was formulated and tested:

TABLE No. 1

| Component | Weight % |
|---|---|
| Polyamide 66 having an amine end | 67.5 |
| group content of from 80 mmol/kg to | |
| 90 mmol/kg and having a melt flow rate | |
| of 91 g/10 min at 275° C. and at a load | |
| of 2.16 kg when tested according to | |
| ISO Test 1133 | |
| Glass fiber coated with sizing | 30 |
| composition | |
| Masterbatch containing a mixture of | 0.50 |
| copolymers and montanic acid | |
| derivatives | |
| Complex of copper, di-u-iodotris | 1.00 |
| (triphenylphosphine)di-and | |
| iodobis(triphenylphosphino) copper | |
| Nigrosine masterbatch | 1.00 |

The polymer composition above was molded into a test specimen and tested for various physical properties after being immersed in a cooling fluid at 130° C. The cooling fluid contained 50% by weight DEX-COOL brand fluid marketed by Prestone and 50% by weight water. The specimens were tested for mechanical properties after 504 hours and after 1,008 hours. The following results were obtained:

TABLE No. 2

| | After 504 hours at | After 1,008 hours at |
|---|---|---|
| Test | 130° C. in cooling fluid | 130° C. in cooling fluid |
| Tensile stress at break | 85.4 | 42.9 |
| (MPa) | | |
| Strain at break (%) | 3.46 | 1.57 |
| Unnotched Charpy | 55.7 | 23 |
| impact resistance (kJ/m²) | | |

Two commercially available glass reinforced polyamide compositions were also tested. After 1,008 hours at 130° C., the commercial products displayed a tensile stress at break of 37.6 MPa and 33.15 MPa, displayed a strain at break of 1.38% and 1.21%, and displayed an unnotched Charpy impact strength of 19.5 KJ/m² and 19 KJ/m². Thus, the composition of the present disclosure significantly outperformed the commercial products.

### Example No. 2

The formulation according to the present disclosure as recited in Example No. 1 was tested for melting temperature and the crystallinity temperature using DSC. The measurements were taken using a Texas Instruments DSC apparatus (Universal V4.5A).

A similar composition was formulated that did not contain nigrosine. The following results were obtained:

| | Melting | Crystallinity |
|---|---|---|
| | temperature | temperature |
| Sample | (° C.) | (° C.) |
| Sample No. 1 | 264 | 219 |
| Sample No. 1 | 263 | 232 |
| without containing | | |
| nigrosine | | |

As shown above, nigrosine lowered the crystallinity temperature of the polymer composition.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A polymer composition well suited for contact with cooling fluids comprising:
a polyamide polymer present in the polymer composition in an amount greater than about 35% by weight, the polyamide polymer containing amine end groups in an amount greater than about 55 mmol/kg;
reinforcing fibers in an amount of from about 5% by weight to about 55% by weight;
a stabilizer comprising a copper compound;
at least one of a lubricant, a nucleating agent, and a crystallizing agent that lowers the crystallization temperature of the polyamide polymer.

2. A polymer composition as defined in claim 1, wherein the polyamide polymer contains amine end groups in an amount greater than about 60 mmol/kg, and less than about 250 mmol/kg.

3. A polymer composition as defined in claim 1, wherein the polyamide polymer is present in the polymer composition in an amount from about 45% by weight to about 85% by weight, such as in an amount from about 60% by weight to about 70% by weight.

4. A polymer composition as defined in claim 1, wherein the reinforcing fibers comprise glass fibers and wherein the glass fibers are present in the polymer composition in an amount from about 15% by weight to about 40% by weight.

5. A polymer composition as defined in claim 1, wherein the reinforcing fibers include a sizing composition present on a surface of the fibers, the sizing composition comprising a hydrolysis-resistant agent.

6. A polymer composition as defined in claim 4, wherein the glass fibers are free of boron.

7. A polymer composition as defined in claim 5, wherein the sizing composition contains a silane.

8. A polymer composition as defined in claim 5, wherein the hydrolysis-resistant agent comprises an anhydride- and/or carboxylic-functionalized polymer, an epoxy-functionalized polymer, or a mixture thereof.

9. A polymer composition as defined in claim 5, wherein the hydrolysis-resistant agent comprises a blocked isocyanate.

10. A polymer composition as defined in claim 1, wherein the stabilizer comprises a copper and organic halogen complex.

11. A polymer composition as defined in claim 1, wherein the stabilizer comprises a complex of copper, di-u-iodotris(triphenylphosphine)di- and iodobis(triphenylphosphino) copper.

12. A polymer composition as defined in claim 1, wherein the stabilizer is present in the polymer composition in an amount greater than about 0.5% by weight, and in an amount less than about 3% by weight.

13. A polymer composition as defined in claim 1, wherein the polymer composition contains the crystallizing agent comprising a nigrosine.

14. A polymer composition as defined in claim 13, wherein the polyamide polymer has a crystallization temperature of less than about 225° C.

15. A polymer composition as defined in claim 1, wherein the polymer composition contains the lubricant comprising a montanic acid derivative.

16. A polymer composition as defined in claim 1, wherein the polymer composition contains the nucleating agent comprising a copolymer.

17. A polymer composition as defined in claim 1, wherein the polymer composition does not contain any semi-aromatic polyamide polymers.

18. A polymer article comprising:
a molded polymer component defining at least a portion of a fluid flow path, the molded polymer component being configured to be a portion of a cooling fluid circuit for circulating a cooling fluid comprising a glycol; and
wherein the molded polymer component is formed from a polymer composition as defined in claim 1.

19. A polymer article as defined in claim 18, wherein the molded polymer component comprises a distribution manifold.

20. A polymer article as defined in claim 18, wherein the molded polymer component comprises a valve component, a housing defining at least one cooling fluid pathway, a radiation expansion tank, or a tube.
